(19) United States
(12) Patent Application Publication
(10) Pub. No.: US 2025/0277719 A1
(43) Pub. Date: Sep. 4, 2025

(54) SYSTEMS AND METHODS FOR DETERMINING NATURAL FREQUENCIES OF ROTATING MACHINERY

(71) Applicant: PURDUE RESEARCH FOUNDATION, West Lafayette, IN (US)

(72) Inventors: Evan Paul PARSHALL, West Lafayette, IN (US); Gregory Matthew SHAVER, Lafayette, IN (US); Shveta Vinayak DHAMANKAR, West Lafayette, IN (US); Anil BAJAJ, West Lafayette, IN (US); John EVANS, West Lafayette, IN (US); Junaid ALI, West Lafayette, IN (US); Tyler SWEDES, West Lafayette, IN (US); Jeff RUNDE, West Lafayette, IN (US)

(21) Appl. No.: 19/067,900

(22) Filed: Mar. 1, 2025

Related U.S. Application Data
(60) Provisional application No. 63/560,436, filed on Mar. 1, 2024.

(51) Int. Cl. G01M 13/028

(52) U.S. Cl. CPC G01M 13/028

(57) ABSTRACT

Systems and/or methods for determining the natural frequencies of rotating machinery systems, including complex rotating machinery systems such as the powertrains of vehicles powered by internal combustion engines, are disclosed. Embodiments include receiving information from a sensor related to the rotation of a component in the drivetrain (such as a rotating toothed gear), calculating a velocity of the component, calculating a transformed velocity of the component (such as by using a Fast Fourier Transform), selecting one or more shaft orders desired for analysis (such as those based on a predetermined set of likely shaft orders), selecting the amplitudes of the select shaft orders, normalizing the amplitudes, mapping the normalized amplitudes to the Hertz domain, calculating local maxima of the normalized amplitudes, and/or identifying frequencies associated with the calculated local maxima. Additional embodiments include repeating the procedures and identifying clusters of local maxima. Further embodiments include windowing the velocity profile.

This application claims the benefit of U.S. Provisional Application No. 63/560,436, filed 1 Mar. 2024, the entirety of which is hereby incorporated herein by reference.

### FIELD

Embodiments of this disclosure relate generally to analysis of rotating machinery, including systems and/or methods for determining natural frequencies, including torsional natural frequencies, of rotating machinery utilizing minimal sensor input.

### BACKGROUND

Systems of rotating machinery have natural frequencies. One example system is a drive system for an automobile, which can include at least one or more engines, transmissions (for example, automatic transmissions), drive shafts, universal joints, differentials and wheels. When these systems operated in regimes that excite these natural frequencies, vibration amplitudes increase which tend to lead to additional wear and tear on the system and premature system failure.

The natural frequencies in a system of rotating machinery can be determined by using computer modeling to analyze the system, but the inventors of the present disclosure realized that these results are valid only for an idealized system and do not precisely represent actual manufactured systems. The natural frequencies of rotating machinery can also be determined through extensive testing a physical/manufactured system, but the inventors also realized that the testing will only be precisely accurate for the physical system that was tested and will serve only as an approximation of other physical/manufactured system that will differ from the tested system due manufacturing inaccuracies and tolerances. Moreover, as the complexity of these systems increase, the ability to accurately determine the natural frequencies becomes increasingly difficult.

It was realized by the inventors of the present disclosure that detecting the natural frequencies of rotating systems can help mitigate vibrations and decrease system wear and tear through, for example, control algorithms. The ability to detect the natural frequencies utilizing minimal sensors (including utilizing only one or more sensors already incorporated into a manufactured rotating machinery system) can dramatically decrease wear and tear on the rotating machinery for minimal cost, such as by signaling that action should be taken and/or applying control algorithms to influence the operation of the rotating machinery based on this information.

### SUMMARY

Embodiments of the present disclosure provide systems and methods for determining natural frequencies of rotating machinery, and in particular embodiments systems and methods for determining torsional natural frequencies of rotating machinery.

Embodiments of the present disclosure include algorithms capable of accurately and efficiently detecting the natural frequencies of rotating machinery, such as rotating shafts in an automobile drivetrain.

Embodiments of the algorithm utilize a Discrete Fourier Transform (in this case, a Fast Fourier Transform (FFT)) with respect to the revolutions of one component of the rotating machinery (such as the transmission output shaft), which may be referred to as performing the Discrete Fourier Transform with respect to the “order” of the rotating component, acquired from rotational speed sensors, which may be added to and/or already integrated into the rotating machinery during their manufacture (such as encoder-based speed sensors in an automatic transmission). The ability to utilize sensors that are already integrated into rotating machinery, potentially for other purposes, has advantages in that additional modifications to the rotating machinery are not required, which dramatically simplifies the time and expense of implementing the embodiments disclosed herein.

Embodiments disclosed herein detect linear and non-linear natural frequencies (e.g., torsional natural frequencies) in rotating machinery, and in particular embodiments in vehicle drivetrains and automatic transmissions.

Embodiments of the present invention also perform the analysis sufficiently fast to enable their use in control algorithms that control the operation of a rotating system in real time.

Additional embodiments include systems and methods that may be added to an existing rotating machinery system (e.g., adding one or more additional sensors and/or processors to a vehicle and/or powertrain) while further embodiments are included as part of a rotating machinery system (e.g., as part of the transmission control unit of a vehicle's transmission) without requiring the addition of additional hardware or software.

Advantages of embodiments of the disclosure include algorithms that can be used to enhance reliability and reduced downtime of rotating systems, such as automotive drivetrains. Further advantages include the ability to determine natural frequencies of complex rotating systems, such as automotive drivetrains, without the need for extensive use of vibration sensors throughout the drivetrain and can be implemented using sensors that are already installed on the rotating machinery by the manufacturer, such as by using information already collected by a transmission controller to control the operation of the transmission.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 is an illustration of a toothed gear and a Hall-effect sensor according to at least one embodiment of the present disclosure.

FIG. 2 is a plot of normalized amplitude versus frequency.

FIG. 3 is a plot of normalized amplitude versus frequency with the peak detection algorithm implemented.

FIG. 4 is a plot of peak prominence vs frequency (Hz) depicting clusters of data points at high prominence values in the range of 90-100 Hertz.

FIG. 5 is a graphical depiction of systems, methods and/or algorithms for determining natural frequencies of rotating machinery according to embodiments of the present disclosure.

FIG. 6 is a diagrammatical view of a computational system according to one embodiment of the present disclosure.

FIG. 7 is a depiction of a vehicle with a powertrain including an engine and a transmission according to embodiments of the present disclosure.

FIG. 8 is an enlarged view of the transmission depicted in FIG. 7.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” that may occur within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

The more complicated the rotating system, the more difficult it becomes to determine one or more natural frequencies of the system. Additionally, when a natural frequency is excited, vibrations can occur that can damage the system. Moreover, these vibrations may not be detectable through typical methods, such as by a driver or a maintenance technician in the case of a vehicle powertrain.

Embodiments of the present disclosure determine and/or estimate the natural frequencies of a rotating system. For example, at least one embodiment includes a processor that receives information from a sensor that detects the rotation of at least one rotating component in a rotating machinery system and determines at least one natural frequency of the rotating machinery system. In at least one example embodiment, the system determines one or more natural frequencies of an automobile drivetrain, which can include, for example, an engine, a transmission, one or more universal joints, one or more shafts (e.g., driveshafts), and/or a differential.

In determining and/or estimating the natural frequencies of the rotating system, a sensor detects the rotation of a component of the rotating system. For example, the sensor can detect the passing of one or more features of the rotating component, such as one or more detectable features (for example, optically detectable markings and/or etchings, and/or magnetic portions) that are attached to and/or features of the rotating component.

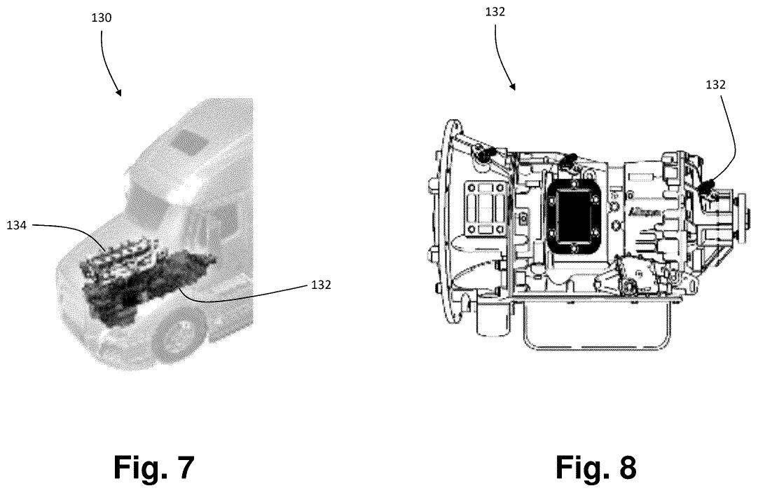

In at least one embodiment, the rotating component is a toothed output gear and/or shaft of an automatic transmission (e.g., transmission 132 as depicted in FIGS. 7 and 8) used as part of the drivetrain (e.g., a drivetrain including engine 134 and transmission 132) of a vehicle (e.g., vehicle 130). In these systems, the output of the automatic transmission can be strongly linked to system fatigue and/or failure, which can result in there being advantages in sensing the rotation of this portion of the drivetrain, i.e., rotating machinery.

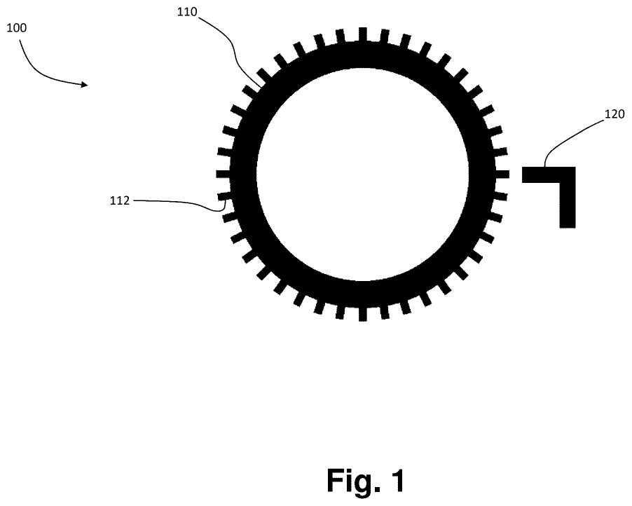

In the example depicted in FIG. 1, the rotating system 100 includes a sensor 120 (for example, a Hall-effect sensor) that detects the passing of each tooth 112 of a rotating gear 110 within the rotating system 100. The sensor 120 senses the rotation of the rotating gear 110 in intervals of angular position since there are a fixed number of samples that occur for every revolution of the rotating gear 110 irrespective of the speed of the rotating gear 110. The number of samples collected for each rotation equals the number of teeth 112 on the toothed gear 110. In some embodiments an additional gear, which may have equally spaced teeth, is attached to the rotating shaft to increase the number of measurements taken for each rotation.

When the number of teeth 112 is sufficiently high, detecting each tooth 112 provided by the additional gear can result in a sufficiently high sampling frequency and increase the fidelity of the measurements. The toothed gear can be spun at the same angular velocity as the rotating shaft. Depicted in FIG. 1 is a toothed gear 110 and a Hall-effect sensor 120 according to at least one example embodiment. In at least one embodiment the toothed gear 110 is mounted around the rotating shaft.

Whenever a tooth 112 passes the sensor 120 a delta time, Δtₙ, is recorded. Each delta time represents the time that a tooth 112 passes the sensor 120 minus the time that the previous tooth 112 passed the sensor 120: (tₙ₊₁−tₙ). This data is displayed in Equation 1 and may be referred to as encoder data. The number of samples collected by the encoder in Equation 1 is N+1.

$$t = [ Δ {t}_{0} , Δ {t}_{1} , Δ {t}_{2} , … , Δ {t}_{N} ] = [ \text{} ( {t}_{1} - {t}_{0} ) , ( {t}_{2} - {t}_{1} ) , ( {t}_{3} - {t}_{2} ) , … , ( {t}_{N + 1} - {t}_{N} ) ] \qquad Equation 1$$

The amount of time encoder data is collected is typically longer than the time required for one rotation of the gear 110, resulting in the number of samples exceeding the number of teeth 112 in gear 110. Although encoder data can be collected for virtually any period of time depending on how much data is desired, in some embodiments the encoder data is collected for up to 1 minute, while in other embodiments the encoder data is collected for up to 20 seconds, and in still other embodiments the encoder data is collected for up to 10 seconds. As described below, these periods where the encoder data is collected can be repeated a desired number of times (e.g., as described below in relation to the repeating of events 210-250) to facilitate a clustering analysis (e.g., as described below in relation to event 255). As such, in some embodiments the total time in which encoder data is collected (e.g., the total time for all repeated time periods) spans several minutes and can last for over one hour.

A numerical differentiation can be carried out to estimate δt, which may be used as the denominator of the derivative operator. In at least one embodiment the numerical differentiation for the first derivative is a central difference equation (see, Equation 2), which in some implementations can be more accurate than the forward or backward difference equations on the encoder data. The central difference equation is represented by Equation 2.

$$δ {t}_{n} \approx \frac{{t}_{n + 2} - {t}_{n}}{2} = \frac{Δ {t}_{n + 1} + Δ {t}_{n}}{2} \qquad Equation 2$$

When the teeth 112 on the toothed gear 110 are equally spaced, the spacing between the teeth 112 of the gear 110 (δθ) can be approximated as one revolution divided by the number of teeth 112 on the toothed gear 110 (Nₜₑₑₜₕ) as represented by Equation 3 wherein δθ is expressed in radians.

$$δ {θ}_{n} \approx \frac{2 π}{{N}_{teeth}} \qquad Equation 3$$

By combining the expressions in Equation 2 and Equation 3, Equation 4 is an expression for a numerical approximation of the angular velocity of the shaft wherein the units of shaft velocity are in radians per second.

$${( \frac{δ θ}{δ t} )}_{n} \approx \frac{4 π}{{N}_{teeth} ( Δ {t}_{n + 1} + Δ {t}_{n} )} = {ω}_{n} \qquad Equation 4$$

With ω denoting the array of velocity data with the length of the velocity array ω being N (which is one less than the length of t), the velocity array ω can be written as in Equation 5.

$$ω = [ {ω}_{0} , {ω}_{1} , {ω}_{2} , … , {ω}_{N - 1} ] \qquad Equation 5$$

After a fixed number of delta time samples are collected, the velocity of the shaft can be calculated using, for example, numerical differentiation. Using this velocity array, the mean velocity of the shaft, ω̅, may be calculated as represented in Equation 6.

$$\overline{ω} = \frac{1}{N} {\sum }_{n = 0}^{N - 1} {ω}_{n} \qquad Equation 6$$

Before carrying out frequency analysis, the velocity profile can be windowed (e.g., applying a mathematical function that is zero-valued outside of a chosen interval) using, for example, the Hanning windowing function as displayed in Equation 7.

$$w = 0.5 ( 1 - cos ( \frac{2 π n}{N} ) ) , 0 \leq n \leq N \qquad Equation 7$$

Windowing will involve pointwise multiplying the velocity profile by the windowing function, which is denoted using the ⊙ operator as represented in Equation 8.

$$ω ⊙ w = [ {ω}_{0} \cdot {w}_{0} , {ω}_{1} \cdot {w}_{1} , {ω}_{2} \cdot {w}_{2} , … , {ω}_{N - 1} \cdot {w}_{N - 1} ] \qquad \underline{Equation 8}$$

After performing a windowing, frequency analysis can be performed. In one example a Discrete Fourier Transform may be used. In at least one embodiment, the Fast Fourier Transform (FFT) (a type of Discrete Fourier Transform) has advantages in that it works well when a digital processor is used to perform the calculations. The FFT may be performed using data that is sampled in equal intervals of time, which will result in the units of frequency being cycles per second (also known as Hertz).

Turning to the encoder data, the velocity data is therefore not sampled in equal intervals of time, but is instead sampled in equal intervals of angular position since for every revolution of the rotating shaft there are a fixed number of samples irrespective of the speed of the rotating shaft. The number of samples collected for each rotation equals the number of teeth 112 on the toothed gear 110. Since data is sampled in equal intervals of position, the units of frequency as measured by the Discrete Fourier Transform are cycles per revolution. Units of frequency expressed in cycles per revolution may be referred to as “order.” Order can be expressed with respect to the velocity of a particular rotating component, such as a shaft. For example, a third transmission output order describes three oscillations in velocity per one revolution of a transmission output shaft, which is the number of oscillations in velocity expected in a transmission that is connected to a 6-cylinder, 4-stroke, internal combustion engine since there are typically three power strokes of the engine cylinders for each rotation of the shaft inputting power to the transmission.

In embodiments wherein only real data (i.e., no imaginary components in the data) is considered, the frequency domain plot of amplitude versus frequency is symmetric about zero and the one-sided FFT can be performed to, for example, decrease the amount of processing that is required. One example of notation that can be used for the one-sided FFT of a windowed signal is displayed in Equation 9. The FFT output amplitude (which in at least some embodiments are assumed to be the absolute value (i.e., the magnitude) of the amplitude) is described as Xₖ wherein k is an integer index.

$${X}_{k} = fft ( ω ⊙ w ) , 0 \leq k < \frac{N}{2} \qquad \underline{Equation 9}$$

The sampling frequency of the encoder data is the number of samples per revolution, which is equal to the number of teeth 112 of the toothed gear 110. In this example the Nyquist frequency is equal to half of the sampling frequency and the one-sided FFT with encoder data outputs the amplitudes of the equally spaced orders ranging from 0 up to, but not including, the Nyquist frequency. This is displayed in Equation 10 wherein k is an integer index.

$${f}_{k} = \frac{{N}_{teeth} \cdot k}{N} , 0 \leq k < \frac{N}{2} \qquad \underline{Equation 10}$$

Since order is representative of the number of oscillations in velocity per one revolution of a rotating shaft and/or gear, the largest amplitudes of oscillations can occur at half and whole number orders. When a drivetrain is experiencing resonance, the amplitudes of the shaft orders can become amplified most notably at half and whole number orders. For this reason, in some embodiments only amplitudes at whole or half orders are considered. In some embodiments wherein this algorithm is implemented on a vehicle (e.g., vehicle 130) with an x-cylinder internal combustion engine (e.g., engine 134), only the whole orders up to the number of shaft velocity changes expected in the system need to be considered. For example, when the algorithm is implemented on a vehicle with a 6-cylinder, 4-stroke internal combustion engine, consideration may be given to only the first, second, and third transmission output orders. However, in still further embodiments more output orders (or in some embodiments only a single output order) may be considered. For example, in additional embodiments where the algorithm is implemented on a vehicle with a 6-cylinder, 4-stroke internal combustion engine, consideration may be given to the one-half (½), first (1), first-and-one-half (1 ½), second (2), second-and-one-half (2½) and third (3) output orders. To find the index corresponding to the desired whole (e.g., 1^{st}, 2^{nd} and/or 3^{rd}) or half (e.g., ½, 1½ and/or 2½) orders, Equation 10 was rearranged to solve for k. The result is displayed as Equation 11.

$$k = \frac{{f}_{k} \cdot N}{{N}_{teeth}} \qquad \underline{Equation 11}$$

In some embodiments, the mean transmission output velocity is increased, which can have advantages in linearly increasing the amplitudes of the transmission output orders and assisting with sections of the velocity profile that do not experience resonance. For example, even under non-resonant conditions, doubling the speed of a driveshaft will typically double the amplitudes of the high frequency orders.

To facilitate detecting resonance, embodiments of the present disclosure normalize the amplitudes of these transmission output orders by the mean transmission output velocity (ω̅). In order to do this, in some embodiments the amplitudes of the selected transmission output orders are divided by the mean transmission output velocity as represented in Equation 12.

$${X}_{k} = {X}_{k} \cdot {( \overline{ω} )}^{- 1} \qquad \underline{Equation 12}$$

Even though in embodiments the FFT outputs the amplitudes of frequencies in units of output order (for example, transmission output order), some embodiments “view” shaft vibrations in units of Hertz, which can have advantages in determining the natural frequencies of the system. One advantage of this is that the rotating systems experiences resonant frequencies in units of Hertz and not in units of order. To make this calculation to “view” the shaft frequencies in units of Hertz, embodiments assume that the shaft is rotating at a steady state during the sampling period. This implies that low frequency velocity components of the velocity signal will stay nearly constant, or at least have minimal fluctuations, over the duration of the signal. At least one reason why this assumption is valid in certain embodiments is because the number of data points used in each FFT correspond to a small number of transmission output revolutions in which velocity does not significantly fluctuate. The formula for conversion from units of shaft order to units of Hertz is displayed in Equation 13.

$${( hz )}_{k} = \frac{\overline{ω} \cdot {f}_{k}}{2 π} \qquad \underline{Equation 13}$$

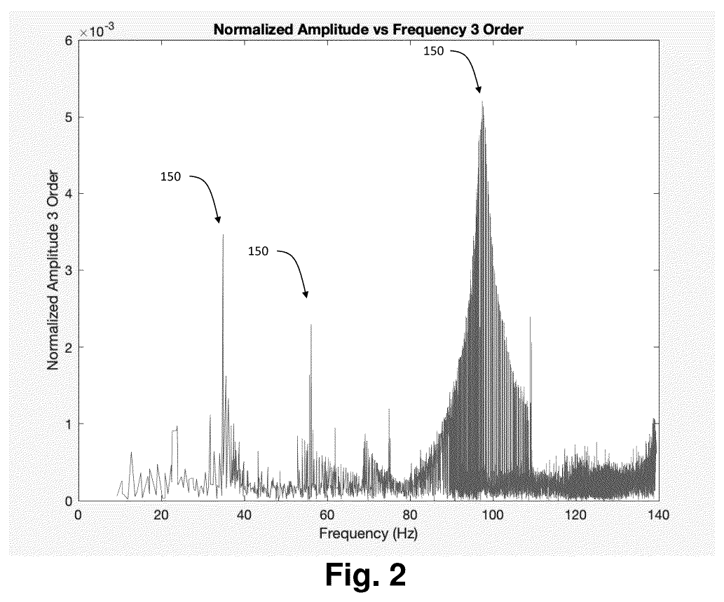

By performing the aforementioned calculations, normalized amplitudes are calculated, and their corresponding frequencies in units of Hertz are determined. The normalized amplitudes and their corresponding frequencies in Hertz are calculated for certain/select orders, for example, each of the selected half and whole number orders. As greater amounts of data are collected, this process of calculating normalized amplitudes and their corresponding frequencies in Hertz for selected orders (for example, half and whole number orders) can be repeated. Once repeated an appropriate number of times, normalized amplitudes can be plotted versus frequencies in Hertz for each of the selected orders. Frequencies corresponding to large peaks in normalized amplitudes in the plots are indicative of strong natural frequency candidates. Using FIG. 2 as an example, the plot of normalized amplitude versus frequency yields results wherein the large peaks correspond to natural frequencies candidates. Evaluating the normalized amplitudes for the third transmission output order in FIG. 2 yield a strong natural frequency candidate that is slightly below 100 Hertz.

While it may be relatively simple for a person to visually see where peaks in relative amplitudes occur on a plot, an appropriate metric is implemented in some embodiments to identify the peaks using an electronic controller (e.g., processor). The metric used in some embodiments is prominence and/or peak prominence. Prominence measures how much a peak (see, e.g., example peaks 150 in FIG. 2) stands out due to its intrinsic amplitude and the amplitude relative to the peaks around it. Prominence can also be defined as how much a peak stands out from its surrounding baseline.

To evaluate the prominence of a peak, some embodiments identify a peak that is a relative maximum point of the signal. At a given relative maximum, a horizontal line is to be extended until it crosses either a higher point in the signal or it crosses an end (the left or right end) of the signal. The range from the left end of the horizontal line to the relative maximum can be referred to as the left interval, and the range from the relative maximum to the right end of the horizontal line can be referred to as the right interval.

In some embodiments, the minimum point of the signal in the left interval is found, which may be referred to as the left interval minima. Additionally, the minimum point of the signal in the right interval is found, which may be referred to as the right interval minima. The maximum of the left and right interval minima may then specify the reference level.

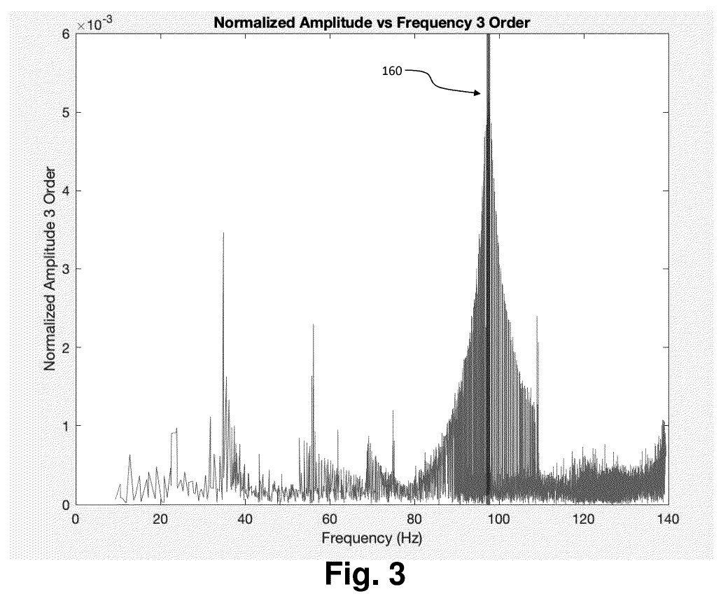

FIG. 3 is an example plot of normalized amplitude versus frequency with a peak detection algorithm implemented. Example of peak detection algorithms used with embodiments of the present disclosure are available online, such as algorithms that may be available on the SciPy.org website, such as at https://docs.scipy.org/doc/scipy/reference/generated/scipy.signal.peak_prominences.html. In at least one embodiment the peak detection algorithm may be found In FIG. 3 the example peak prominence metric that was used to analyze the data displays a strong natural frequency candidate (peak prominence 160) just below 100 Hertz, which is also the overall maximum peak prominence for the depicted example data set and is depicted with a thick vertical line.

The peak prominence can be defined as the difference between the selected relative maximum and the reference level. In embodiments using this definition, large peak prominence indicates stronger candidates for natural frequencies. Note that in at least one example embodiment the normalized amplitudes are first sorted in the order of the frequency in Hertz they corresponded to before the peak prominence algorithm is performed on the data. One rationale for this is that the velocity profile at some points slopes downward leading to frequencies in Hertz that are not in ascending order. The selected peak prominence metric correctly identifies the dominant peak in FIG. 2, which is displayed using the vertical line (which is red in a color rendering) in FIG. 3.

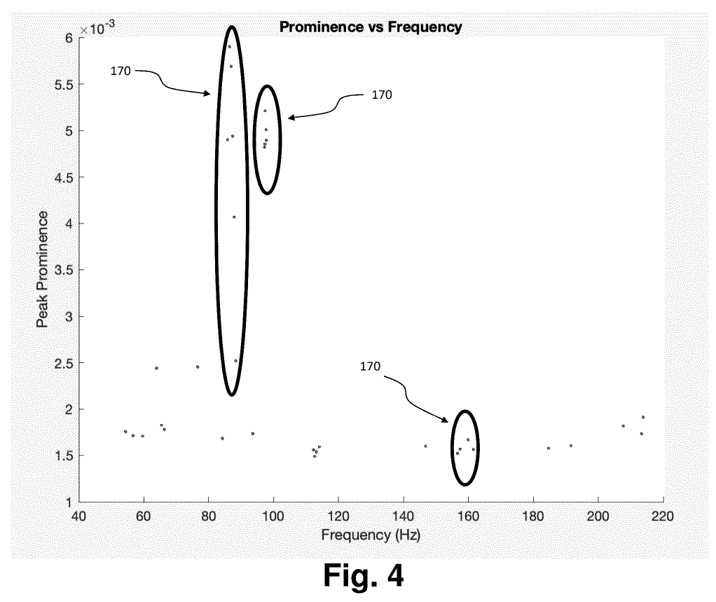

The process of collecting data, calculating normalized amplitudes with their corresponding frequencies in Hertz, and evaluating prominence can be repeated multiple times. As different velocity profiles are performed and diverse data is collected, variations in peak prominence at differing frequencies in Hertz may be observed. An example plot of the largest prominence values versus frequency in Hertz is displayed in FIG. 4. In order to identify a natural frequency, embodiments observe large peak prominence. In some embodiments detecting and/or observing clusters 170 of data points is beneficial since real-world conditions can lead to identification of outliers in the calculated prominence and frequency values, which can correspond to important natural frequencies of the rotating system 100. Using FIG. 4 as an example, a strong natural frequency candidate can be seen in the 90-100 Hertz range.

Since in at least some embodiments the amplitudes of the transmission output orders are normalized by the mean velocity, low mean velocities have the potential to become strong natural frequency candidates. Therefore, in some embodiments, a minimum frequency for natural frequency candidates can be set to address this effect, one example utilizing FIG. 4 is to set a minimum frequency at or around 40 Hertz. However, in some embodiments this is not expected to have a significant adverse impact since the most damaging natural frequencies tend to be above this minimum frequency.

In embodiments of the present disclosure the natural frequency candidates of the system are determined purely by analyzing only the velocity at a point in the rotating machinery, such as the output of an automotive transmission. No other measurements or additional sensors are required. As such, embodiments of the present disclosure can be used with sensors that are already included on the rotating machinery, such as requiring nothing more than the rotational speed sensor that is included on the output shaft of modern transmissions.

While damaging vibrations are observable at one point of the rotational machinery (such as at the output of a transmission), vibrational excitation can also occur at different portions of the rotating machinery (such as at the engine that is driving an automotive transmission). Using a fully functional four-stroke six-cylinder engine as an example, a significant portion (and possibly a majority) of the high frequency content can be present at the engine third order since there are three cylinder firings per one revolution of the engine crankshaft. Since in this example the engine can also be responsible for exciting the system, the amplitude of the high frequency excitation can be analyzed to determine whether it fluctuates significantly. In at least one example system with fully functional four-stroke six-cylinder engine and transmission that was analyzed, fluctuation of the amplitude of the high frequency excitation was not significant. However, malfunctions in the power generation and/or storage system (which include, for example, engine malfunctions and malfunctions in hybrid engine architectures) of the powertrain can affect the results yielded by the natural frequency detection algorithms, such as variations in the excitation amplitudes.

Additional and/or alternative natural frequency detection algorithms according to embodiments of the present disclosures include collecting a fixed number of samples of raw-tooth gear data using a sensor measuring a component of the rotating machinery, and storing this data in memory, such as RAM on a controller.

Numerical differential methods can then be used to calculate the transmission output velocity from the raw-tooth encoder data.

The average velocity may then be calculated from the velocity data.

The velocity data may then be windowed using, for example, a Hanning window.

A Discrete Fourier Transform (DFT) of the windowed velocity data may then be taken (using the FFT). The frequency may be kept in units of transmission output order.

A fixed number of whole or half orders (for example, 0.5, 1.0, 1.5, 2.0, 2.5, 3.0, etc.) may then be selected on which to perform detailed analysis.

For the selected orders, the amplitudes output from the DFT may be divided by the average velocity to normalize the amplitude.

Frequency for the selected orders may then be converted to units of Hertz using, for example, a pseudo-steady-state approximation as represented by Equation 14.

$${f}_{Hz} = \frac{{ω}_{rpm , ss} \cdot {f}_{order}}{60} \qquad \underline{Equation 14}$$

After the DFT is complete, the selected orders, normalized amplitudes of the selected orders, and average velocity may be saved in RAM for later use in normalizing the data. Other data can be overwritten to conserve memory.

This process can be repeated using data of fixed sample length to calculate more normalized amplitudes of the selected orders and average velocities and record them in RAM.

Natural frequencies will be present at frequencies in Hertz where the normalized amplitudes suddenly rise.

Using information given by normalized amplitude versus frequency in Hertz, sudden rises in amplitude may be detected using a metric of peak prominence. This metric may be used to find the peaks. In some embodiments the normalized amplitudes are sorted in the order of the frequency in Hertz they correspond to before calculating peak prominence. In still further embodiments, local peak prominences that are within a predetermined range of the maximum overall peak prominence are included for further analysis while local peak prominences that are outside the predetermined range are excluded from further analysis. In some embodiments the predetermined range includes local peak prominences that are 50% or greater of the maximum overall peak prominence, while in further embodiments the predetermined range includes local peak prominences that are 65% or greater of the maximum overall peak prominence, while in still further embodiments while in further embodiments the predetermined range includes local peak prominences that are 75% or greater of the maximum overall peak prominence.

Frequencies that appear in clusters (e.g., clusters 170) and correspond to the high peak prominences may be deemed as natural frequency candidates. These natural frequencies and their prominences may then be saved in flash.

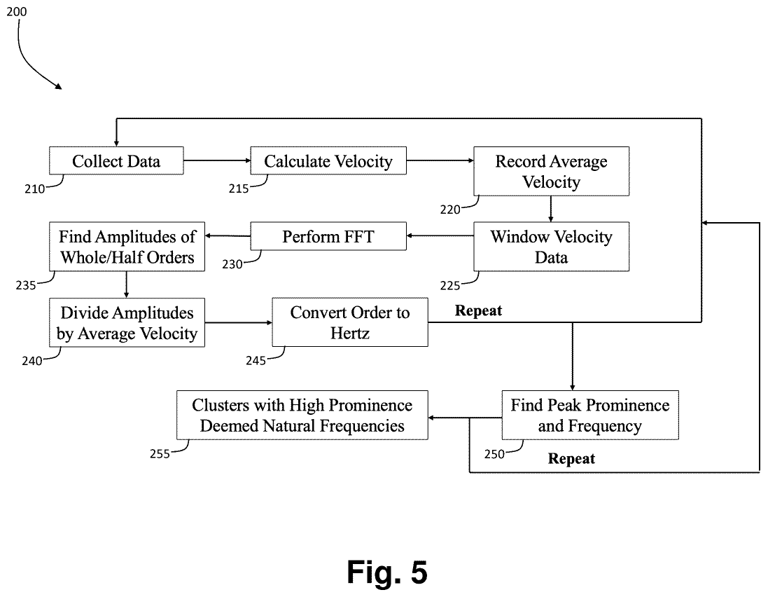

Depicted in FIG. 5 is a flowchart illustrating example systems, methods and/or algorithms 200 for determining one or more natural frequencies of rotating machinery according to embodiments of the present disclosure.

Event 210 includes collecting data from one or more components of a rotating system (e.g., rotating system 100), such as measuring a rotating component at the output of a vehicle transmission. As an example, event 210 may be accomplished by measuring At for each tooth 112 passing sensor 120 as described in the discussion of Equation 1 in this document.

Event 215 includes calculating the velocity δt of the component and ωₙ, such as by performing numerical differentiation on Δt as described in the discussion of Equations 2-5 in this document.

Event 220 includes calculating and recording the mean velocity ω̅ of the rotating component such as, for example, performing the procedures as described above in relation to Equation 6.

Event 225 is an optional event that includes windowing the velocity data ω, such as, for example, performing the procedures described above in relation to Equations 7 and 8. One or more window functions may be applied to the one or more average velocities. One example window function that may be used is the Hanning window function.

Event 230 includes performing frequency analysis on the velocity profile, such as by performing a Discrete Fourier Transform (for example, a Fast Fourier Transform (FFT)) on the windowed velocity data. In some embodiments the procedures described above in relation to Equations 9 and 10 are used.

Event 235 includes using the results of the frequency analysis to determine the amplitudes of select orders, such as by utilizing one or more of the procedures described above in relation to Equation 11. The specific orders that are selected (e.g., the specific whole and half orders selected) can be varied depending on the specific analysis being performed. In some embodiments a Power Spectral Density (PSD) function is applied to the results of the Fourier Transform, which can be advantageous since it removes time dependencies of the amplitudes in the Fourier Transform analysis. As an example, applying a PSD function can remove the impact of time duration of vibrations in the Fourier Transform analysis. One example PSD function is Welch's method. In some embodiments, the exact amplitudes that are found will correspond to whole number orders, while in other embodiments the amplitudes that are found will correspond to whole and half order orders.

In some embodiments a spectrogram of the data is performed, which has advantages in determining the orders and velocities the vibrations at specific frequencies in Hertz occur. Different embodiments determine amplitudes based on different numbers of orders. Embodiments utilizing a larger number of orders will typically find (identify) more natural frequencies but will typically be more computationally expensive, which can result in a slower process than embodiments utilizing a smaller number of orders. Some embodiments utilize only whole orders, while other embodiments utilize whole and half orders. The maximum order used in some embodiments is limited to not exceeding one-half the number of teeth on the rotating gear that is being sensed.

Event 240 includes normalizing the amplitudes of the velocity data after the amplitudes are identified. In one example, the amplitudes are normalized by dividing the amplitudes by the average velocity, such as is represented above in relation to Equation 12. One advantage of performing event 240 is that it facilitates the detection of natural frequency candidates when transforming the order information to Hertz.

Event 245 includes conversion of the order information to Hertz as described above in relation to Equations 13 and 14.

The above process of events 210 through 245 may be repeated one or more times collecting additional data and performing the above procedures on the additional data.

Once the above process of events 210 through 245 is performed a desired number of times, event 250 may be performed, which can identify peak prominence and frequency as addressed above.

Once the peak prominence and frequency is identified in event 250, the entire process beginning at event 210 can be repeated by collecting additional data, performing events 215 through 245, and in some embodiments repeating the data collection 210 and performing the events 215 through 245 a desired number of times, then identifying/finding peak prominence and frequency as in event 250.

Event 255 may then be performed to identify clusters with high prominence and identify natural frequencies of the system as addressed above in relation to FIGS. 2-4.

Advantages of the systems and methods described herein include the ability to perform real-time analysis and/or constant monitoring of rotating machinery during operation of the rotating machinery. Using vehicle powertrains as an example, embodiments of the present disclosure permit real-time monitoring of the operation of the powertrain, which can be used to, for example:
indicate to the driver that the transmission should be shifted when the transmission is operating at a natural frequency that could cause damage;
automatically shift the transmission to avoid operation of the transmission at one or more frequencies that could result in excessive wear and tear;
detect when a new natural frequency appears, which can indicate a change in one or more powertrain components indicating excessive wear and tear;
detect the appearance of an unexpected natural frequency, which can indicate an improper repair of the transmission, such as an incorrect or substandard component (e.g., a component that isn't as stiff or has an incorrect moment of inertia) having been installed;
indicate to the driver (or a fleet manager) that the vehicle should be brought in for maintenance and/or further analysis; and/or
predict and/or determine if a natural frequency of the powertrain (which may be otherwise undetectable by the driver or maintenance personnel) is occurring in a frequency range that is known to be problematic.

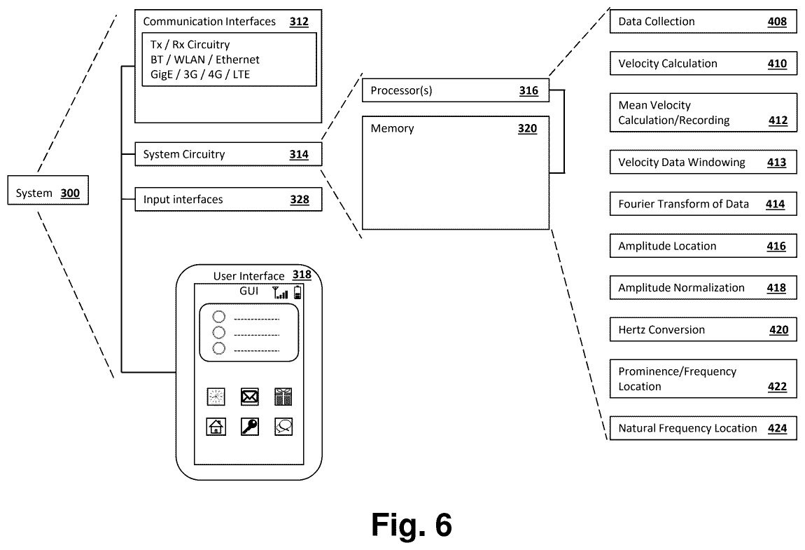

FIG. 6 illustrates a system, such as a system for determining natural frequencies of rotating machinery 300, according to at least one embodiment of the present disclosure. The system 300 may be used to implement the procedures and methods disclosed herein and may include one or more communication interfaces 312, one or more input interfaces 328 and/or system circuitry 314. The system circuitry 314 may include one or more processors 316. Alternatively or in addition, the system circuitry 314 may include one or more memory units 320.

The one or more processors 316 may be in communication with the one or more memory units 320. In some examples, the one or more processors 316 may also be in communication with additional elements, such as one or more communication interfaces 312, one or more input interfaces 328, and/or one or more user interfaces 318. Examples of the one or more processors 316 may include one or more of the following: general processors, central processing units, logical CPUs/arrays, microcontrollers, servers, application specific integrated circuits (ASIC), digital signal processors, field programmable gate arrays (FPGA), graphics processing units (GPU), and/or digital circuits, analog circuits, or some combinations thereof.

The one or more processors 316 may be one or more devices operable to execute logic. The logic may include computer executable instructions or computer code stored in the one or more memory units 320 or in other memory that when executed by the one or more processors 316, cause the one or more processors 316 to perform the operations of (or for) one or more data collection deployments 408 (which may include one or more sensors), one or more velocity calculation deployments 410, one or more average velocity calculation and/or recording deployments 412, one or more velocity data windowing deployments 413, one or more Fourier transform deployments 414, one or more amplitude determination deployments 416, one or more amplitude normalization deployments 418, one or more frequency domain conversion deployments 420, one or more prominence and/or frequency determination deployments 422, and/or one or more natural frequency determination deployments 424. The computer code may include instructions executable with the one or more processors 316.

The one or more memory units 320 may be any device(s) for storing and retrieving data or any combination thereof. The one or more memory units 320 may include non-volatile and/or volatile memory, such as a random-access memory (RAM), read-only memory (ROM), erasable programmable read-only memory (EPROM) and/or flash memory. Alternatively or in addition, the one or more memory units 320 may include one or more optical drives, magnetic (e.g., “hard”) drives, solid-state drives or any other form of data storage device. The one or more memory units 320 may include at least one of the one or more data collection deployments 408, the one or more velocity calculation deployments 410, the one or more average velocity calculation and/or recording deployments 412, the one or more velocity data windowing deployments 413, the one or more Fourier transform deployments 414, the one or more amplitude determination deployments 416, the one or more amplitude normalization deployments 418, the one or more frequency domain conversion deployments 420, the one or more prominence and/or frequency determination deployments 422, and/or the one or more natural frequency determination deployments 424. Alternatively or in addition, the memory may include any other component or subcomponent of the system 300 described herein.

The one or more user interfaces 318 may include any interface for displaying graphical information. The system circuitry 314 and/or the one or more communications interfaces 312 may communicate signals or commands to the one or more user interfaces 318 that may cause one or more user interfaces to display graphical information. Alternatively or in addition, the one or more user interfaces 318 may be remote to the system 300 and/or the system circuitry 314. The one or more communication interfaces 182 may communicate instructions, such as HTML, to the one or more user interfaces 318 to cause the one or more user interfaces 318 to display, compile, and/or render information content. In some examples, the content displayed by the one or more user interfaces 318 may be interactive or responsive to user input. For example, the one or more user interfaces 318 may communicate signals, messages, and/or information back to the one or more communications interface 312 and/or to the system circuitry 314.

The system 300 may be implemented in many ways. In some examples, the system 300 may be implemented with one or more logical components. For example, the one or more logical components of the system 300 may be hardware or a combination of hardware and software. The one or more logical components may include the one or more data collection deployments 408, the one or more velocity calculation deployments 410, the one or more average velocity calculation and/or recording deployments 412, the one or more velocity data windowing deployments 413, the one or more Fourier transform deployments 414, the one or more amplitude determination deployments 416, the one or more amplitude normalization deployments 418, the one or more frequency domain conversion deployments 420, the one or more prominence and/or frequency determination deployments 422, the system 300 and/or any component or subcomponent of the system 300. In some examples, each of the one or more logic components may include one or more application specific integrated circuits (ASIC), one or more Field Programmable Gate Arrays (FPGA), one or more digital logic circuits, one or more analog circuits, one or more combinations of discrete circuits, gates, or any other type of hardware or combination thereof. Alternatively or in addition, each component may include memory hardware, such as a portion of the one or more memory units 320, for example, that comprise instructions executable with the one or more processors 316 and/or one or more other processors to implement one or more of the features of the logical components. When any one of the logical components includes a portion of the memory that comprises instructions executable with the one or more processors 316, the component may or may not include the one or more processors 316. In some examples, each logical component may just be the portion of the one or more memory units 320 or other physical memory that comprises instructions executable with the one or more processors 316, or other processor(s), to implement the features of the corresponding component without the component including any other hardware. Because each component can include at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, and/or read from one or more types of computer readable storage media. Examples of the computer readable storage medium may include one or more of the following: hard disks, floppy disks, CD-ROM units, flash drives, caches, volatile memory units, non-volatile memory units, RAM units, flash memory units, and/or any other type of computer readable storage medium or storage media. The computer readable storage medium may include one or more of any type of non-transitory computer readable medium, such as one or more CD-ROMs, volatile memories, non-volatile memories, ROM units, RAM units, and/or other suitable storage devices.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may be implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

Embodiments of the present disclosure can be implemented on a computer with previously collected data, while still further embodiments can be implemented in real time, such as by using a controller for the rotating machinery (e.g., a transmission controller). Some embodiments utilize MATLAB (e.g., MATLAB 2022) for data processing and analysis. Additional embodiments utilize Python for generating spectrograms. Some embodiments may utilize algorithms similar to algorithms available in various libraries, such as the Matplotlib and SciPy libraries. Additional embodiments can use software platforms (e.g., MATLAB Simulink) to convert algorithms disclosed herein into formats that are readable by component that are installed by the manufacturer on complex rotating machinery systems, such as Transmission Control Units (TCUs).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed herein may be provided on computer readable storage media. The functions, acts or tasks illustrated in the figures or described herein may be executed in response to one or more sets of logic or instructions stored in or on computer readable media. The functions, acts or tasks are independent of the particular type of instruction sets, storage media, processors or processing strategies and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other types of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

Reference systems that may be used herein can refer generally to various directions (e.g., upper, lower, forward and rearward), which are merely offered to assist the reader in understanding the various embodiments of the disclosure and are not to be interpreted as limiting.

To clarify the use of and to hereby provide notice to the public, the phrases “at least one of A, B, . . . and N” or “at least one of A, B, . . . N, or combinations thereof” or “A, B, . . . and/or N” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. As one example, “A, B and/or C” indicates that all of the following are contemplated: “A alone,” “B alone,” “C alone,” “A and B together,” “A and C together,” “B and C together,” and “A, B and C together.” If the order of the items matters, then the term “and/or” combines items that can be taken separately or together in any order. For example, “A, B and/or C” indicates that all of the following are contemplated: “A alone,” “B alone,” “C alone,” “A and B together,” “B and A together,” “A and C together,” “C and A together,” “B and C together,” “C and B together,” “A, B and C together,” “A, C and B together,” “B, A and C together,” “B, C and A together,” “C, A and B together,” and “C, B and A together.”

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

### Element Numbering

Table 1 includes element numbers and at least one word used to describe the element and/or feature represented by the element number. However, none of the embodiments disclosed herein are limited to these descriptions. Other words may be used in the description or claims to describe a similar member and/or feature, and these element numbers can be described by other words that would be understood by a person of ordinary skill reading and reviewing this disclosure in its entirety.

TABLE 1

| | |
|---|---|
| 100 | rotating machinery |
| 110 | gear |
| 112 | tooth |
| 120 | sensor |
| 130 | vehicle |
| 132 | transmission |
| 134 | engine |
| 150 | peak |
| 160 | peak prominence |
| 170 | data cluster |
| 200 | system |
| 210 | data collection |
| 215 | velocity calculation |
| 220 | average velocity recording |
| 225 | data windowing |
| 230 | Fourier transform performance |
| 235 | amplitude determination |
| 240 | amplitude normalization |
| 245 | Hertz conversion |
| 250 | prominence and frequency determination |
| 255 | natural frequency determination |
| 300 | system |
| 312 | communication interface |
| 314 | system circuitry |
| 328 | input interface |
| 318 | user interface |
| 316 | processor |
| 320 | memory |
| 408 | data collection |
| 410 | velocity calculation |
| 412 | mean velocity calculation and/or recording |
| 413 | velocity data windowing |
| 414 | Fourier transform |
| 416 | amplitude determination |
| 418 | amplitude normalization |
| 420 | frequency conversion |
| 422 | prominence and/or frequency determination |
| 424 | natural frequency determination |

What is claimed is:

1. An apparatus for determining one or more natural frequencies of a rotating machinery system, comprising:
one or more processors configured to
receive first information from a sensor, the received first information related to the rotation of a rotating component of a rotating machinery system during a first time period, wherein
the rotating machinery system is a vehicle transmission that is connected to an internal combustion engine,
the rotating component is a toothed gear of the transmission, and
the received first information includes one or more time intervals (Δt) between adjacent teeth of the toothed gear,
determine one or more first natural frequencies of the rotating machinery system using the first received information by
calculating a first velocity (ω) of the rotating component using the first received information,
calculating a first transformed velocity by applying a Fast Fourier Transform of the first calculated velocity,
selecting one or more first rotational machinery (shaft) orders desired for analysis based on a predetermined set of likely rotational machinery (shaft) orders expected to include high amplitudes due to expected system dynamics,
selecting the first amplitudes of the first select orders of the first transformed velocity,
normalizing the first amplitudes of the first select orders,
mapping the first normalized amplitudes to the frequency (Hertz) domain,
calculating first local maxima across the first mapped normalized amplitudes versus frequency (Hertz),
identifying a first set of frequencies (Hertz) associated with the first local maxima that are within a predetermined range of the maximum overall first local maximum; and
provide to a user the identified frequencies at which there is clustering of the largest peak prominences.

2. The apparatus of claim 1, further comprising after said calculating the first velocity (w) and before performing the Fast Fourier Transform:
calculating a first average velocity ω̅ of the rotating component,
windowing the first velocity profile after said calculating the first average velocity ω̅ of the rotating component.

3. The apparatus of claim 2, wherein
windowing the first velocity profile includes performing the following windowing equation
$$ω ⊙ w = [ {ω}_{0} \cdot {w}_{0} , {ω}_{1} \cdot {w}_{1} , {ω}_{2} \cdot {w}_{2} , … , {ω}_{N - 1} \cdot {w}_{N - 1} ]$$
where w is the Hanning windowing function and the ⊙ operator involves pointwise multiplication of the first velocity profile by the windowing function, and
calculating the first transformed velocity includes applying the Fast Fourier Transform to the windowed first velocity profile using
$${X}_{k} = fft ( ω ⊙ w ) , 0 \leq k < \frac{N}{2}$$
where Xₖ is the FFT output and k is an integer index.

4. The apparatus of claim 1, wherein after said receiving first information and said determining a natural frequency of the rotating machinery system using the first received information, the one or more processors are configured to:
receive second information from the sensor, the received second information related to the rotation of a rotating component of a rotating machinery system during a second time period,
determine one or more second natural frequencies of the rotating machinery system using the second received information by
calculating a second velocity (ω) of the rotating component using the second received information,
calculating a second transformed velocity by applying the Fast Fourier Transform of the second calculated velocity,
selecting one or more second rotational machinery (shaft) desired for analysis based on the predetermined set of likely rotational machinery (shaft) orders expected to include high amplitudes due to expected system dynamics,
selecting the second amplitudes of the second select orders of the second transformed velocity,
normalizing the second amplitudes of the second select orders,
mapping the second normalized amplitudes to the frequency (Hertz) domain,
calculating second local maxima across the second mapped normalized amplitudes versus frequency (Hertz),
identifying a second set of frequencies (Hertz) associated with the second local maxima that are within a predetermined range of the maximum overall second local maximum; and
identifying the frequencies in the first and second sets of frequencies (Hertz) associated with the first and second local maxima at which there is clustering of the largest peak prominences; and
wherein said provide to a user the identified frequencies includes providing to the user the frequencies at which there is clustering for the first and second information from the sensor.

5. The apparatus of claim 4, wherein after said receiving second information and said determining a natural frequency of the rotating machinery system using the second received information, the one or more processors are configured to:
repeat the elements of claim 4 for additional sets of information from the sensor during additional time periods;
wherein said provide to a user the identified frequencies includes providing to the user the frequencies at which there is clustering for the first, second and the additional information from the sensor.

6. The apparatus of claim 5, wherein the velocity of the vehicle during the first time period is different than the velocity of the vehicle during the second time period.

7. The apparatus of claim 1, wherein
calculating the first velocity ωₙ of the rotating component includes performing numerical differentiation on the first time intervals Δt as
$${ω}_{n} = \frac{4 π}{{N}_{teeth} ( Δ {t}_{n + 1} + Δ {t}_{n} )} \approx {( \frac{δ θ}{δ t} )}_{n}$$
$$where$$
$$\begin{matrix}δ {θ}_{n} \approx \frac{2 π}{{N}_{teeth}} \\ δ {t}_{n} \approx \frac{{t}_{n + 2} - {t}_{n}}{2} = \frac{Δ {t}_{n + 1} + Δ {t}_{n}}{2} \\ t = [ Δ {t}_{0} , Δ {t}_{1} , Δ {t}_{2} , … , Δ {t}_{N} ] = [ ( {t}_{1} - {t}_{0} ) , ( {t}_{2} - {t}_{1} ) , ( {t}_{3} - {t}_{2} ) , … , ( {t}_{N + 1} - {t}_{N} ) ]\end{matrix}$$
and Nₜₑₑₜₕ=the number of sampling events per rotation of the rotating component.

8. The apparatus of claim 1, wherein
the first average velocity ω̅ is calculated as
$$\overline{ω} = \frac{1}{N} {\sum }_{n = 0}^{N - 1} {ω}_{n}$$
where ωₙ is the first velocity of the rotating component.

9. The apparatus of claim 1, wherein
the first amplitude Xx associated with each shaft order fₖ is calculated as
$${X}_{k} = fft ( ω ) , 0 \leq k < \frac{N}{2}$$
and fₖ is defined as
$${f}_{k} = \frac{{N}_{teeth} \cdot k}{N} , 0 \leq k < \frac{N}{2}$$
where k is an integer index.

10. The apparatus of claim 1, wherein
the selected one or more first rotational machinery (shaft) orders desired for analysis include an order equal to the number of ignitions of the internal combustion engine expected for each revolution of the rotating component.

11. The apparatus of claim 10, wherein
the one or more first rotational machinery orders selected for analysis include orders equal to every half-order and every whole-order up to a maximum order equal to the number of ignitions of the internal combustion engine expected for each revolution of the rotating component.

12. The apparatus of claim 1, further comprising:
calculating a first average velocity of the rotating component,
wherein said normalizing the first amplitudes includes evaluating
$${\hat{X}}_{k} = {X}_{k} \cdot {( \overline{ω} )}^{- 1}$$
where \hat{X}ₖ is the first normalized amplitude, Xₖ is the first amplitude of order fₖ, and ω̅ is the first average velocity of the rotating component.

13. The apparatus of claim 1, wherein
said mapping the first normalized amplitudes to the frequency (Hertz) domain includes
$${( hz )}_{k} = \frac{\overline{ω} \cdot {f}_{k}}{2 π}$$
where (hz)ₖ is the first normalized amplitude, ω̅ is the first average rotational velocity, fₖ is the shaft order, and k is an integer index.

14. The apparatus of claim 1, wherein
said calculating local maxima includes calculating first peak prominences across the mapped normalized amplitudes versus frequency (Hertz).

15. The apparatus of claim 1, wherein
said identifying the first set of frequencies includes selecting peak prominences that are within a present percentage of the maximum overall peak prominence.

16. The apparatus of claim 1, wherein
said identifying the frequencies associated with the first local maxima that are within a predetermined range of the maximum overall peak prominence includes selecting the frequencies (Hertz) that are within 75% of the maximum overall peak prominence.

17. The apparatus of claim 1, further comprising after said calculating the first velocity (ω) and before performing the Fast Fourier Transform:
calculating a first average velocity ω̅ of the rotating component,
windowing the first velocity profile after said calculating the first average velocity ω̅ of the rotating component,
wherein
windowing the first velocity profile includes performing the following windowing equation
$$ω ⊙ w = [ {ω}_{0} \cdot {w}_{0} , {ω}_{1} \cdot {w}_{1} , {ω}_{2} \cdot {w}_{2} , … , {ω}_{N - 1} \cdot {w}_{N - 1} ]$$
where w is the Hanning windowing function and the ⊙ operator involves pointwise multiplication of the first velocity profile by the windowing function, and
calculating the first transformed velocity includes applying the Fast Fourier Transform to the windowed first velocity profile using
$${X}_{k} = fft ( ω ⊙ w ) , 0 \leq k \leq \frac{N}{2}$$
where Xₖ is the FFT output and k is an integer index;
calculating the first velocity ωₙ of the rotating component includes performing numerical differentiation on the time intervals Δt as
$${ω}_{n} = \frac{4 π}{{N}_{teeth} ( Δ {t}_{n + 1} + Δ {t}_{n} )} \approx {( \frac{δ θ}{δ t} )}_{n}$$
$$where$$
$$\begin{matrix}{δθ}_{n} \approx \frac{2 π}{{N}_{teeth}} \\ δ {t}_{n} \approx \frac{{t}_{n + 2} - {t}_{n}}{2} = \frac{Δ {t}_{n + 1} + Δ {t}_{n}}{2} \\ t = [ Δ {t}_{0} , Δ {t}_{1} , Δ {t}_{2} , … , Δ {t}_{N} ] = [ ( {t}_{1} - {t}_{0} ) , ( {t}_{2} - {t}_{1} ) , ( {t}_{3} - {t}_{2} ) , … , ( {t}_{N + 1} - {t}_{N} )\end{matrix}$$
and Nₜₑₑₜₕ=the number of sampling events per rotation of the rotating component;
the first average velocity ω̅ is calculated as
$$\overline{ω} = \frac{1}{N} {\sum }_{n = 0}^{N - 1} {ω}_{n}$$
the first amplitude Xₖ associated with each shaft order fₖ is calculated as
$${X}_{k} = fft ( ω ) , 0 \leq k < \frac{N}{2}$$
and fₖ is defined as
$${f}_{k} = \frac{{N}_{teeth} \cdot k}{N} , 0 \leq k < \frac{N}{2}$$
where k is an integer index;
the selected one or more rotational machinery (shaft) orders desired for analysis include an order equal to the number of ignitions of the internal combustion engine expected for each revolution of the rotating component;
the internal combustion engine has a total of x cylinders and the one or more rotational machinery orders include an order equal to x/2;
said normalizing the amplitudes includes evaluating
$${\hat{X}}_{k} = {X}_{k} \cdot {( \overline{ω} )}^{- 1}$$
where \hat{X}ₖ is the normalized amplitude, Xₖ is the amplitude of order fₖ, and ω̅ is the average velocity of the rotating component;
said mapping the normalized amplitudes to the frequency (Hertz) domain includes
$${( hz )}_{k} = \frac{\overline{ω} \cdot {f}_{k}}{2 π}$$
where (hz)ₖ is the normalized amplitude, ω̅ is the average rotational velocity, fₖ is the shaft order, and k is an integer index;
said calculating local maxima includes calculating peak prominences across the mapped normalized amplitudes versus frequency (Hertz);
said selecting the frequencies includes selecting peak prominences that are within a present percentage of the maximum overall peak prominence; and
said identifying the frequencies associated with the local maxima that are within a predetermined range of the maximum overall peak prominence includes selecting the frequencies (Hertz) that are within a predetermined range of the maximum overall peak prominence.

18. The apparatus of claim 1, further comprising:
the sensor; and
the vehicle transmission to which the sensor is attached.

19. A method for determining one or more natural frequencies of a rotating machinery system, comprising:
receiving, by a device, information from a sensor, the received information related to the rotation of a rotating component of a rotating machinery system during a time period, wherein
the rotating machinery system is a vehicle transmission that is connected to an internal combustion engine,
the rotating component is a toothed gear of the transmission, and
the received information includes one or more time intervals (Δt) between adjacent teeth of the toothed gear,
generating, by the device, output data based identifying one or more natural frequencies of the rotating machinery system using the received information, wherein said generating includes
calculating a velocity (ωₙ) of the rotating component includes performing numerical differentiation on the time intervals Δt as
$${ω}_{n} = \frac{4 π}{{N}_{teeth} ( Δ {t}_{n + 1} + Δ {t}_{n} )} \approx {( \frac{δ θ}{δ t} )}_{n}$$
$$where$$
$$\begin{matrix}{δθ}_{n} \approx \frac{2 π}{{N}_{teeth}} \\ δ {t}_{n} \approx \frac{{t}_{n + 2} - {t}_{n}}{2} = \frac{Δ {t}_{n + 1} + Δ {t}_{n}}{2} \\ t = [ Δ {t}_{0} , Δ {t}_{1} , Δ {t}_{2} , … , Δ {t}_{N} ] = [ ( {t}_{1} - {t}_{0} ) , ( {t}_{2} - {t}_{1} ) , ( {t}_{3} - {t}_{2} ) , … , ( {t}_{N + 1} - {t}_{N} )\end{matrix}$$
and Nₜₑₑₜₕ=the number of sampling events per rotation of the rotating component;
calculating an average velocity ω̅ of the rotating component using
$$\overline{ω} = \frac{1}{N} {\sum }_{n = 0}^{N - 1} {ω}_{n}$$
windowing the velocity profile after said calculating the average velocity ω̅ of the rotating component by performing the following windowing equation
$$ω ⊙ w = [ {ω}_{0} \cdot {w}_{0} , {ω}_{1} \cdot {w}_{1} , {ω}_{2} \cdot {w}_{2} , … , {ω}_{N - 1} \cdot {w}_{N - 1} ]$$
where w is the Hanning windowing function and the ⊙ operator involves pointwise multiplication of the velocity profile by the windowing function,
calculating a transformed velocity of the shaft order fₖ by applying a Fast Fourier Transform of the calculated velocity using
$${X}_{k} = fft ( ω ⊙ w ) , 0 \leq k < \frac{N}{2}$$
where Xₖ is the FFT output, fₖ is defined as
$${f}_{k} = \frac{{N}_{teeth} \cdot k}{N} , 0 \leq k < \frac{N}{2}$$
and k is an integer index;
selecting one or more rotational machinery (shaft) orders desired for analysis based on a predetermined set of likely rotational machinery (shaft) orders expected to include high amplitudes due to expected system dynamics,
selecting the amplitudes of the select orders of the transformed velocity,
normalizing the amplitudes of the select orders by evaluating
$${\hat{X}}_{k} = {X}_{k} \cdot {( \overline{ω} )}^{- 1}$$
where \hat{X}ₖ is the normalized amplitude, Xₖ is the amplitude of order fₖ, and ω̅ is the average velocity of the rotating component;
mapping the normalized amplitudes to the frequency (Hertz) domain by evaluating
$${( hz )}_{k} = \frac{\overline{ω} \cdot {f}_{k}}{2 π}$$
where (hz)ₖ is the normalized amplitude, ω̅ is the average rotational velocity, fₖ is the shaft order, and k is an integer index;
calculating local maxima across the mapped normalized amplitudes versus frequency (Hertz) by calculating peak prominences across the mapped normalized amplitudes versus frequency (Hertz);
selecting the frequencies (Hertz) associated with peak prominences that are within a predetermined range of the maximum overall peak prominence; and
providing, by the device, the identified frequencies at which there is clustering of the largest peak prominences.
